(19) United States
(12) Patent Application Publication
(10) Pub. No.: US 2024/0271416 A1
(43) Pub. Date: Aug. 15, 2024

(54) MULTIFUNCTIONAL BUILDING PANEL STRUCTURES, ARRANGEMENTS, AND METHODS

(71) Applicant: Tremco CPG Inc., Beachwood, OH (US)

(72) Inventors: Brian Edward Turner, East Greenwich, RI (US); Phillip David Effler, Macedonia, OH (US); Humayun Mandal, Warwick, RI (US); Robert William Dazel, Monroe, MI (US); Mason Averill, Copley, OH (US)

(21) Appl. No.: 18/420,242

(22) Filed: Jan. 23, 2024

Related U.S. Application Data
(60) Provisional application No. 63/440,491, filed on Jan. 23, 2023.

(51) Int. Cl. E04B 1/70; B32B 3/06; B32B 3/30; E04B 1/76

(52) U.S. Cl. CPC E04B 1/70; B32B 3/06; B32B 3/30; E04B 1/7629; B32B 2250/02; B32B 2307/304; B32B 2607/00

(57) ABSTRACT

An insulative panel includes a panel body having opposed front and rear surfaces extending between first and second lateral edges and between first and second longitudinal edges, with a plurality of recessed drainage channels formed in the rear surface and extending from the first longitudinal edge to the second longitudinal edge.

### CROSS-REFERENCE TO RELATED APPLICATION

This application claims priority to and all benefit of U.S. Provisional Patent Application Ser. No. 63/440,491, filed on Jan. 23, 2023, for MULTIFUNCTIONAL EXTERIOR INSULATION AND FINISH SYSTEM STRUCTURES, the entire disclosure of which is incorporated herein by reference.

### BACKGROUND

Building panels are often used to provide functional and/or aesthetic features to a building façade. One example of a panel-based façade cladding is an Exterior Insulation and Finish System (EIFS). As defined by the International Building Code and ASTM International, an EIFS is a non-load bearing, exterior wall cladding system that is formed from insulation boards or panels attached to an exterior substrate (e.g., building wall); an integrally reinforced base coat; and a textured protective finish coat. EIFS structures may be used to provide a weather resistant, seamless, insulated finish to a residence or commercial building.

### SUMMARY OF THE DISCLOSURE

In an exemplary embodiment of the present disclosure, an insulative panel includes a panel body having opposed front and rear surfaces extending between first and second lateral edges and between first and second longitudinal edges, with a plurality of recessed drainage channels formed in the rear surface and extending from the first longitudinal edge to the second longitudinal edge.

In another exemplary embodiment of the present disclosure, an insulative panel includes a panel body having opposed front and rear surfaces extending between first and second lateral edges and between first and second longitudinal edges, and a plurality of elongated rigid struts secured to the rear surface of the panel body, with end portions extending beyond the first and second longitudinal edges of the panel body for fastening to a building substrate.

In another exemplary embodiment of the present disclosure, an insulative panel includes a panel body having opposed front and rear surfaces extending between first and second lateral edges and between first and second longitudinal edges, and a reinforcing material secured to the front surface of the panel body. The front surface of the panel body comprises a textured surface defining raised portions and recessed portions. The reinforcement material is adhered to the raised portions of the textured surface, and a basecoat is disposed over the reinforcement material and between the reinforcement material and the recessed portions of the textured surface to at least partially encapsulate the reinforcement material in the basecoat.

In another exemplary embodiment of the present disclosure, a method of installing an exterior insulation and finish system is contemplated. In the exemplary method, an insulative panel is provided having a panel body having opposed front and rear surfaces extending between first and second lateral edges and between first and second longitudinal edges, with a plurality of recessed drainage channels formed in the rear surface and extending from the first longitudinal edge to the second longitudinal edge. The rear surface of the panel body is secured to an exterior surface of a building structure using one or more non-drying/curing attachment arrangements.

In another exemplary embodiment of the present disclosure, a method of installing an exterior insulation and finish system is contemplated. In the exemplary method, an insulative panel is provided having a panel body having opposed front and rear surfaces extending between first and second lateral edges and between first and second longitudinal edges, and a plurality of elongated rigid struts secured to the rear surface of the panel body, with end portions extending beyond the first and second longitudinal edges of the panel body. The end portions of the plurality of elongated rigid struts are fastened to a building substrate.

In another exemplary embodiment of the present disclosure, a method of fabricating an insulative panel is contemplated. In the exemplary method, a panel body is provided having opposed front and rear surfaces extending between first and second lateral edges and between first and second longitudinal edges, the front surface comprising a textured surface defining raised portions and recessed portions. A reinforcing material is adhered to the raised portions of the textured surface. A liquid basecoat is applied to the front surface of the panel body, such that the basecoat is disposed over the reinforcement material and between the reinforcement material and the recessed portions of the textured surface to at least partially encapsulate the reinforcement material in the basecoat.

### BRIEF DESCRIPTION OF THE DRAWINGS

Further features and advantages of the invention will become apparent from the following detailed description made with reference to the accompanying drawings, wherein:

FIG. 1 illustrates a perspective view of a conventional exterior insulation and finish system;

FIG. 2 illustrates a front perspective view of an insulative panel, according to an exemplary embodiment of the present disclosure;

FIG. 3 illustrates a rear perspective view of the insulative panel of FIG. 2;

FIG. 3A illustrates a rear perspective view of another insulative panel, according to another exemplary embodiment of the present disclosure;

FIG. 4 illustrates a rear perspective view of another insulative panel, according to an exemplary embodiment of the present disclosure;

FIG. 4A illustrates a rear perspective view of another insulative panel, according to another exemplary embodiment of the present disclosure;

FIG. 4B illustrates a rear perspective view of another insulative panel, according to another exemplary embodiment of the present disclosure;

FIG. 5 illustrates a front perspective view of another insulative panel, according to an exemplary embodiment of the present disclosure;

FIG. 6 illustrates a rear perspective view of the insulative panel of FIG. 5;

FIG. 6A illustrates a top view of another insulative panel, according to an exemplary embodiment of the present disclosure;

FIG. 6B illustrates a top view of another insulative panel, according to an exemplary embodiment of the present disclosure;

FIG. 6C illustrates a top view of another insulative panel, according to an exemplary embodiment of the present disclosure;

FIG. 6D illustrates a top view of another insulative panel, according to an exemplary embodiment of the present disclosure;

FIG. 7 illustrates a rear perspective view of another insulative panel, according to an exemplary embodiment of the present disclosure;

FIG. 8 illustrates a front perspective view of another insulative panel, according to an exemplary embodiment of the present disclosure;

FIG. 9 illustrates a rear perspective view of the insulative panel of FIG. 8;

FIG. 10 illustrates a rear perspective view of another insulative panel, according to an exemplary embodiment of the present disclosure;

FIG. 11 illustrates a partial side perspective view of an insulative panel, according to an exemplary embodiment of the present disclosure;

FIG. 12 illustrates a side view of another insulative panel, according to another exemplary embodiment of the present disclosure;

FIG. 13 illustrates a partial top cross-sectional view of another insulative panel, according to another exemplary embodiment of the present disclosure; and

FIG. 14 illustrates a partial top cross-sectional view of another insulative panel, according to another exemplary embodiment of the present disclosure.

### DETAILED DESCRIPTION

This Detailed Description merely describes exemplary embodiments and is not intended to limit the scope of the claims in any way. Indeed, the invention as claimed is broader than and unlimited by the described embodiments, and the terms used have their full ordinary meaning. For example, while certain exemplary features presented in the present disclosure are described and/or shown as being used with building panels for an Exterior Insulation and Finish System (EIFS), any one or more of the features described herein may be utilized with or incorporated into other types of building façade cladding, including, for example, continuous insulation (CI) panels.

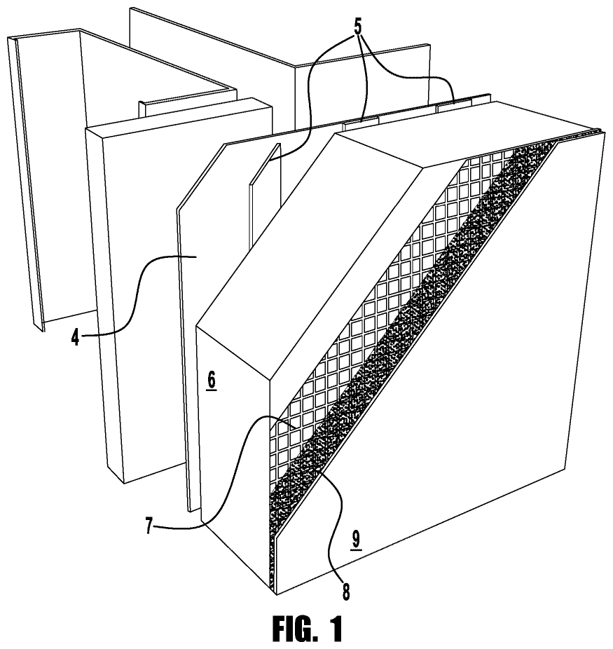

In conventional EIFS applications, as shown in FIG. 1, an air/weather barrier 4 (e.g., a polymer-based, liquid applied water-resistive barrier, such as the Backstop® formulations manufactured by Dryvit, or a butyl-based, acrylic polymer based, or other “peel and stick” composite membrane, such as ExoAir air barrier membranes, manufactured by Tremco) is applied to a sheathing 3 (e.g., gypsum board, plywood, oriented strand board, cement board, glass mat) and is allowed to dry over a first period (e.g., day one). A notched or spaced wet adhesive 5 (e.g., cementitious adhesives, spray foam adhesives, including isocyanate spray foam adhesive, gunnable moisture cure adhesives) is applied to a front surface of the air/weather barrier or to a rear surface of the insulative panel and a plurality of insulative panels or boards 6 are adhered to the air/weather barrier, by the notched adhesive, in a continuous array using the notched adhesive, which is allowed to dry over a second period (e.g., day two). Front surfaces of the insulative boards 6 are rasped to provide planar alignment between adjacent uneven boards over a third period (e.g., day three). A wet basecoat 8 (e.g., cementitious material for impact and/or fire resistance) is then applied to the prepared or rasped front surfaces of the insulative boards, with a reinforcing mesh material 7 (e.g., fiberglass or polypropylene mesh of various densities, provided from a roll of material) embedded in the basecoat before allowing the basecoat to dry over a fourth period (e.g., day four). A wet finish layer 9 (e.g., acrylic or other weather resistant coating, may or may not contain texturizing agent) is then applied over the basecoat and allowed to dry over a fifth period (e.g., day five). As noted, this installation process may take up to five days, or longer, and requires skilled implementation of multiple installation steps and/or additional labor in material clean-up and aesthetic corrective actions.

According to an exemplary aspect of the present disclosure, an EIFS arrangement may be adapted or configured to eliminate one or more conventional EIFS installation steps, for example, to reduce the time for installation and/or the amount of skilled labor required for installation.

In one such exemplary arrangement, an insulative panel for an EIFS arrangement may be provided with a panel body of insulation material (e.g., foam) having a rear surface having one or more recessed channels for providing drainage of moisture disposed between the panel and the air/weather barrier. Such an arrangement may replace the conventional notched adhesive defining drainage channels and may provide for consistent drainage space without reliance on proper application of a notched adhesive by the installer. These recessed channels may be formed in the insulative panel, for example, by sawing, molding, embossing, and/or hotwire cutting.

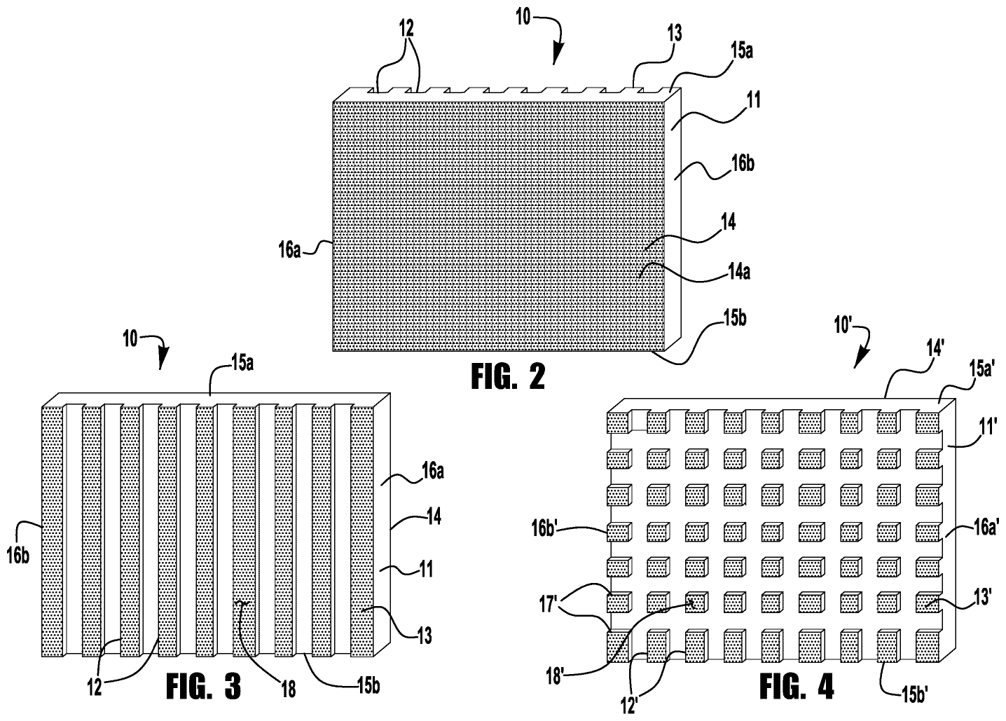

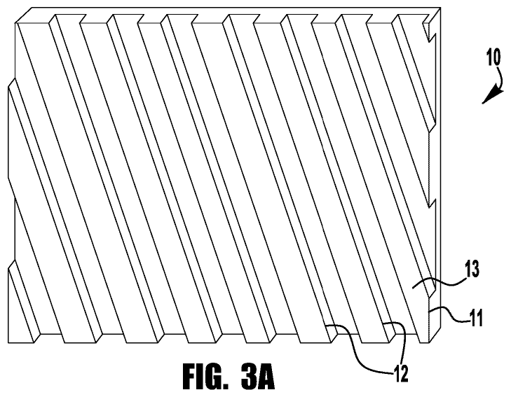

FIGS. 2, 3, and 3A illustrate exemplary insulative panels 10 including a panel body 11 having a plurality of parallel spaced apart (e.g., evenly spaced) recessed channels 12 formed in the rear surface 13 of the panel body 11, extending at least partially vertically (e.g., at an angle from horizontal, as shown in FIG. 3A, or fully vertically, as shown in FIG. 3), as in the orientation shown, between first and second longitudinal edges 15a, 15b.

While the recessed channels may extend in a parallel, vertical direction to provide desired drainage, in some embodiments, the rear surface of the panel body may also be provided with crossing channels (e.g., horizontal or at an angle between vertical and horizontal), for example, to provide for cross-flow drainage (e.g., in the event that one of the vertical channels is blocked or impeded), or to allow for installation of the panel in a 90-degree rotated orientation (e.g., with “vertical” channels extending horizontally and cross-channels extending vertically).

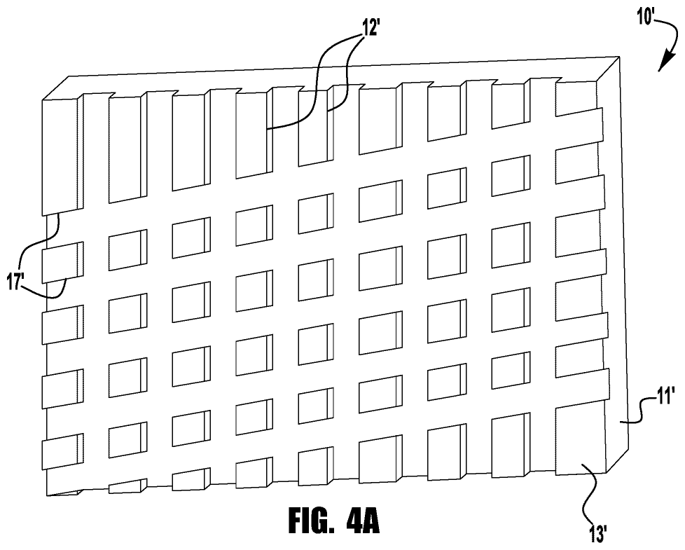

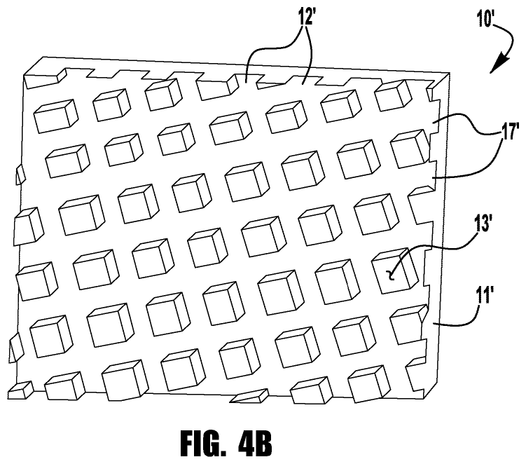

FIGS. 4, 4A, and 4B illustrates an exemplary insulative panel 10′ having a panel body 11′ having a plurality of parallel spaced apart (e.g., evenly spaced) vertical recessed channels 12′ and a plurality of parallel spaced apart (e.g., evenly spaced) horizontal recessed channels 17′ formed in the rear surface 13′ of the panel body 11′, extending at least partially horizontally (e.g., at an angle between vertical and horizontal, as shown in FIG. 4A, or fully horizontally, as shown in FIG. 4) across the vertical recessed channels between first and second lateral edges 16a′, 16b′. In the exemplary embodiment of FIG. 4B, the vertical recessed channels 12′ and the horizontal recessed channels 17′ extend in diagonal, crossing directions on the panel body 11′, forming a diamond pattern of non-recessed portions on the rear surface. In such an arrangement, either orientation of the panel (i.e., with the lateral edges forming top and bottom edges or with the longitudinal edges forming top and bottom edges) will provide a vertical, drainage facilitating component to the horizontally extending channels.

Other types and shapes of drainage recesses may additionally or alternatively be provided in the rear surface of the panel body, including, for example, diagonally extending recesses, or spaced-apart raised features (e.g., diamonds, circles, rectangles, or any other suitable shape) defining surrounding channels. The drainage channels may be provided with a variety of depths, including, for example, at least 1 mm, at least 2 mm, or at least 10 mm channel depth, and may be provided with a variety of channel widths, including, for example at least 5 mm, at least 15 mm, or at least 25 mm, or any other depth and width dimensions as may be desired for drainage efficiency or required by jurisdictional compliance. The illustrated embodiments of FIGS. 3-4B show evenly spaced channels of uniform width across the panel surface with spacing between channels similar to the width of the channel. In other embodiments, the channels may have varying widths and/or varying spacing. Additionally or alternatively, the channels may be further spaced apart, with spacing between channels exceeding channel width, for example, by a ratio of at least 2:1, or at least 3:1, or at least 4:1. Such increased spacing may provide for increased surface engagement between the panel rear surface and the building substrate (e.g., against the air/weather barrier), for example, to receive sufficient adhesive for adhesion to the building substrate in embodiments relying at least partially on adhesion for attachment of the panels.

With drainage channels formed in the insulative panel, and not by notched adhesive applied between the panel and the air/weather barrier, other arrangements for fastening the panel to the air/weather barrier may be utilized, including, for example, fastening arrangement that do not require significant curing/drying time for a field applied adhesive. For example, the non-recessed portions of the rear surface 13, 13′ of the panel body 11, 11′ may be provided with a pre-applied pressure sensitive adhesive 18, 18′ (e.g., acrylic transfer adhesives, butyl rubber adhesives, or other pressure sensitive adhesive materials) for attachment of the insulative panel to the wall/structure. In some such embodiments, one or more disposable liners may be provided over the pressure sensitive adhesive. In other embodiments, a front surface of the air/weather barrier (e.g., an air barrier membrane) may be provided with a pre-applied pressure sensitive adhesive (e.g., acrylic transfer adhesives, butyl rubber adhesives, or other pressure sensitive adhesive materials) for attachment of the non-recessed portions of the panel rear surface to the wall/structure.

In still other embodiments, the insulative panel(s) may additionally or alternatively be secured to the wall/structure by one or more mechanical fasteners, including, for example, threaded fasteners (e.g., bolts, screws) installed through apertures in the panel bodies, and/or rigid struts (e.g., steel, aluminum, rigid plastic, such as polypropylene) secured to the panel bodies and attachable by mechanical fasteners (e.g., nails, screws, staples) to the wall/structure. In some such embodiments, the insulative panel may be initially (e.g., less securely) fastened to the wall/structure by a pressure sensitive adhesive, with the pressure sensitive adhesive facilitating positioning of the panel on the wall while more securely attaching the panel to the wall using mechanical fasteners. These attachment arrangements may be selected and configured to meet desired EIFS/ASTM performance standards, such as, for example, ASTM E2568, Standard Specification for PB Exterior Insulation and Finish Systems.

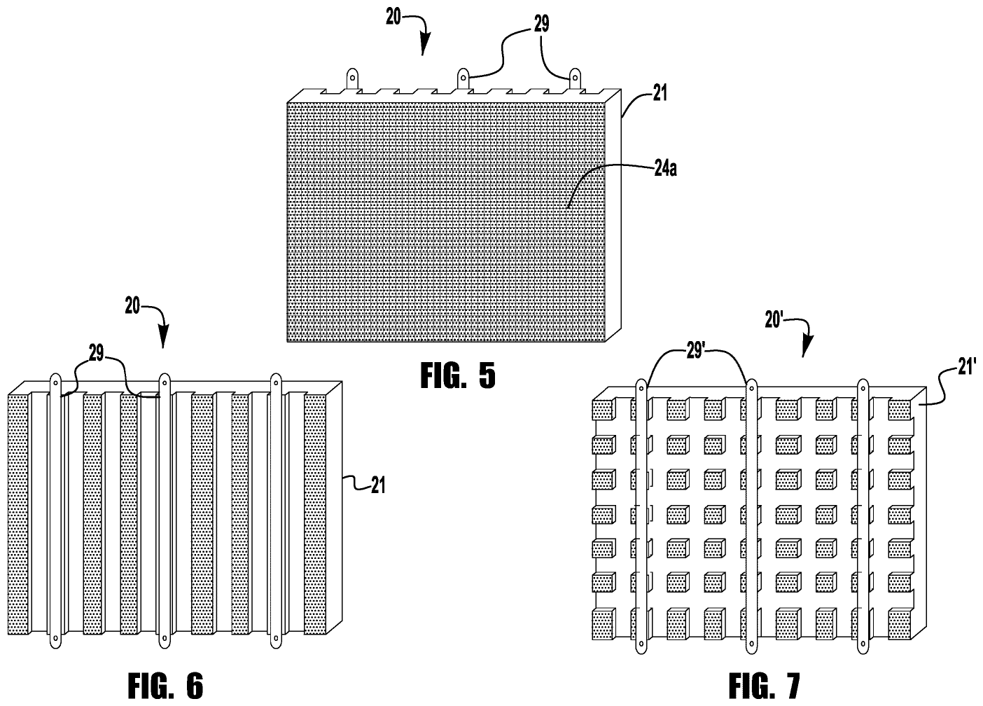

FIGS. 5-7 illustrate exemplary insulative panels 20, 20′ having a plurality of rigid struts 29, 29′ secured to a rear side of the panel body 21, 21′. In some embodiments, protruding portions of the struts may be received in corresponding channels or grooves of an adjacent panel, for example, to facilitate alignment of the adjacent panels. The struts 29, 29′ may be at least partially embedded into, or received in mating channels or grooves in, the rear side of the panel body, for example, to allow for planar engagement of the panel rear surface with the air/weather barrier front surface. End portions of the struts 29, 29′ may extend beyond the edges of the panel body 21, 21′ for attachment (e.g., using screws or other fasteners installed through apertured end portions of the struts) to the building substrate.

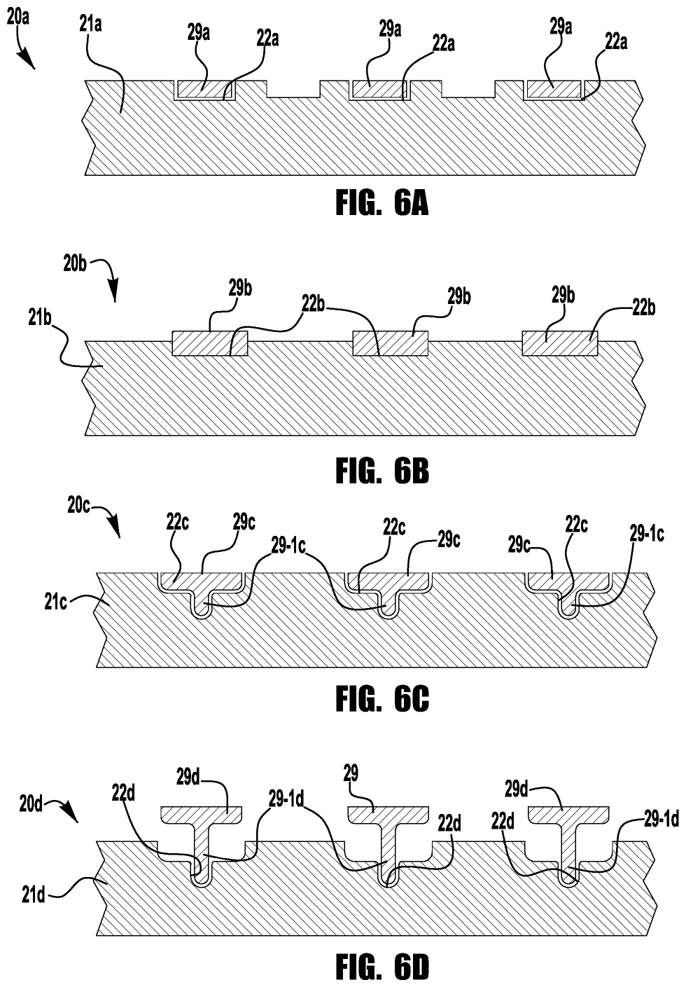

As shown in FIG. 6A, the rear side of the panel body 21a may include channels or grooves 22a sized to fully receive and retain the struts 29a (e.g., using press fit, adhesive, or coextruded retention), such that the rear surfaces of the struts are flush with the rear surface of the panel body. As shown in FIG. 6B, the rear side of the panel body 21b may include channels or grooves 22b sized to only partially receive and retain the struts 29b (e.g., using press fit, adhesive, or coextruded retention), such that an offset is provided between the rear side of the panel 20b, for example, to provide a drainage space or plane between the panel 20b and the building substrate (e.g., without requiring drainage channels on the rear surface of the panel body).

In other embodiments, mounting struts may be provided with a snap fit (e.g., elastically biased or resilient) rib or projection configured to snap into a corresponding groove in the panel body. As shown in FIG. 6C, the rear side of the panel body 21c may include channels or grooves 22c sized to fully receive and retain the struts 29c and to interlock with rib portions 29-1c of the struts (e.g., using resilient, snap fit retention), such that the rear surfaces of the struts are flush with the rear surface of the panel body. As shown in FIG. 6D, the rear side of the panel body 21d may include grooves 22d sized to only receive and retain the rib portions 29-1d of the struts 29d (e.g., using resilient, snap fit retention), such that an offset is provided between the rear side of the panel 20d, for example, to provide a drainage space or plane between the panel 20d and the building substrate (e.g., without requiring drainage channels on the rear surface of the panel body).

While the struts are shown as extending vertically, in other embodiments, the panel may be provided with horizontally extending struts or struts extending at some other angle.

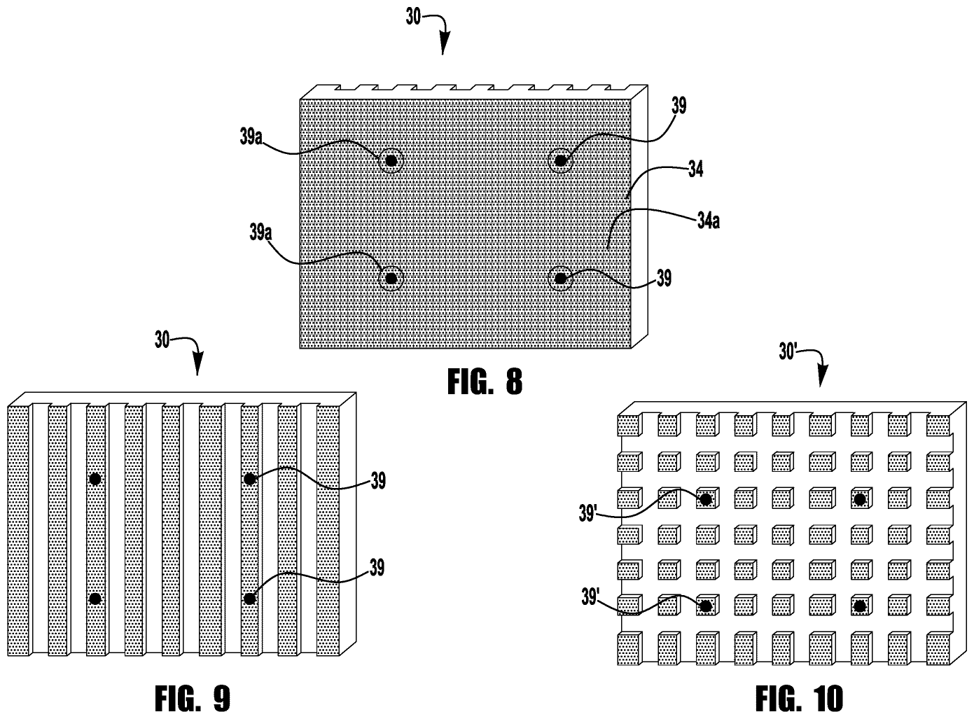

FIGS. 8-10 illustrate exemplary insulative boards 30, 30′ having a plurality of mounting holes 39, 39′ extending through the board for attachment by mechanical fasteners (e.g., screws, bolts—not shown) to the wall/structure. The mounting holes may be provided with countersunk openings 39a so that the fasteners may be installed flush with or recessed from the board front surface. Washers may be provided in the countersunk openings, for example, to bear the force of the tightened fastener head (e.g., to prevent damage to the panel).

In other embodiments, a panel may utilize two or more fastening arrangements, including, for example, two or more of the fastening arrangements described herein (e.g., pressure sensitive adhesive, mounting struts, through-fasteners, wet adhesive) to securely attach the panels.

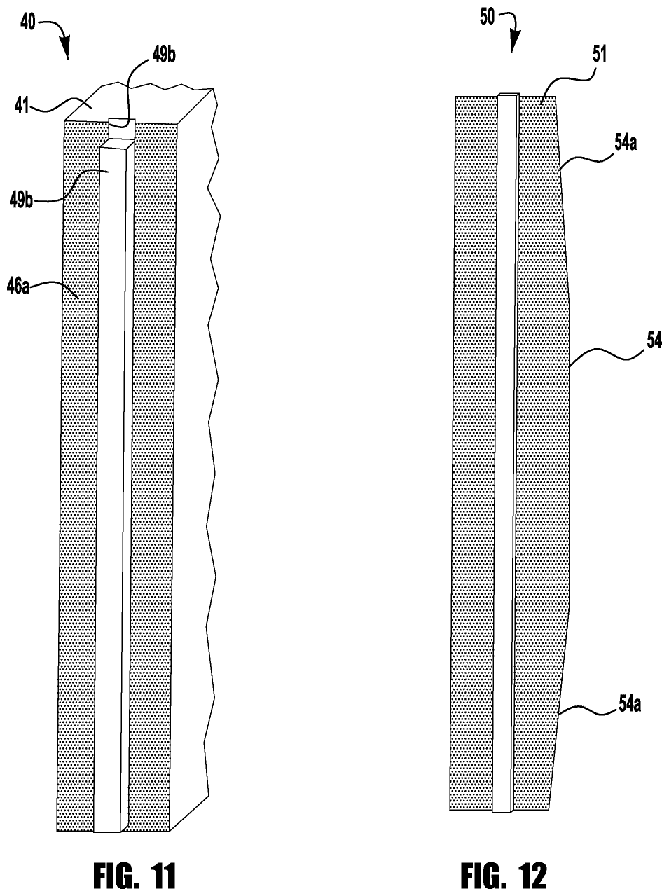

According to another exemplary aspect of the present disclosure, insulative panels for an EIFS arrangement may be provided with edge portions having one or more interlocking or alignment features for aligned engagement with adjacent insulative panels during installation. As one example, as shown in FIG. 11, an edge portion 46a of a panel body 41 of an insulative panel 40 may be provided with a groove portion 49a interlocking with a strut portion 49b that also interlocks with a groove portion of an adjacent installed panel (not shown). Other exemplary arrangements (not shown) may utilize interlocking tongue and groove portions, interlocking peg and hole/socket portions, or some other loose fit, press fit, snap fit, or other such interlocking geometric joint. These interlocking/aligning features may facilitate front surface planar alignment of adjacent boards, potentially minimizing or eliminating the need for rasping (at least for the purpose of surface leveling) or other such leveling of the board front surfaces upon installation. Additionally, when provided in combination with the rear drainage channels described above, these alignment features may ensure alignment of the drainage channels, for example, to prevent blockage or reduced drainage flow caused by misaligned drainage channels. In other arrangements, lateral drainage may be facilitated in the presence of any misaligned drainage channels (e.g., due to the absence of alignment features, or in spite of such alignment features) by inclusion of a longitudinal edge chamfer, kerf, diagonal cut, or other such feature provided on the rear side of the panel or panels.

According to another exemplary aspect of the present disclosure, insulative panels for an EIFS arrangement may be provided with edge portions having outward tapered front surfaces defining a recessed front surfaces at the adjoining edges of adjacent installed panels. These recessed adjoining edge portions may facilitate application of a reinforcing material (e.g., overlapping mesh) along the adjoining edges of the insulative panels, for example, for fire testing or impact resistance performance, while eliminating or minimizing protrusion of these reinforcement materials, making it easier to provide a planar front surface when an architectural coating (e.g., basecoat and/or finishing coatings) are applied. FIG. 12 illustrates a side view of an exemplary insulative panel 50 having a panel body 51 with a front surface 54 having tapered edge portions 54a (with the degree of taper exaggerated for illustrative purposes).

According to another exemplary aspect of the present disclosure, a reinforcing material 14a, 24a, 34a (FIGS. 2, 5, and 8) (e.g., woven mesh, non-woven mat, or solid facer materials including, e.g., fiberglass, polypropylene, other suitable polymers and plastics) of a desired composition, pattern, or density may be pre-applied to an insulative panel, for example, to improve impact resistance of the EIFS arrangement and/or to eliminate the need to include an embedded mesh layer in the field applied basecoat layer. In some exemplary embodiments, the reinforcing material may be adhered to the front surface of the panel, using, for example, a pressure sensitive adhesive. In other exemplary embodiments, the reinforcing material may be laminated to the front surface of the panel using, for example, an adhesive, such as a pressure sensitive adhesive. In still other exemplary embodiments, the reinforcement material may be included in the panel during formation (e.g., injection molding) of the panel.

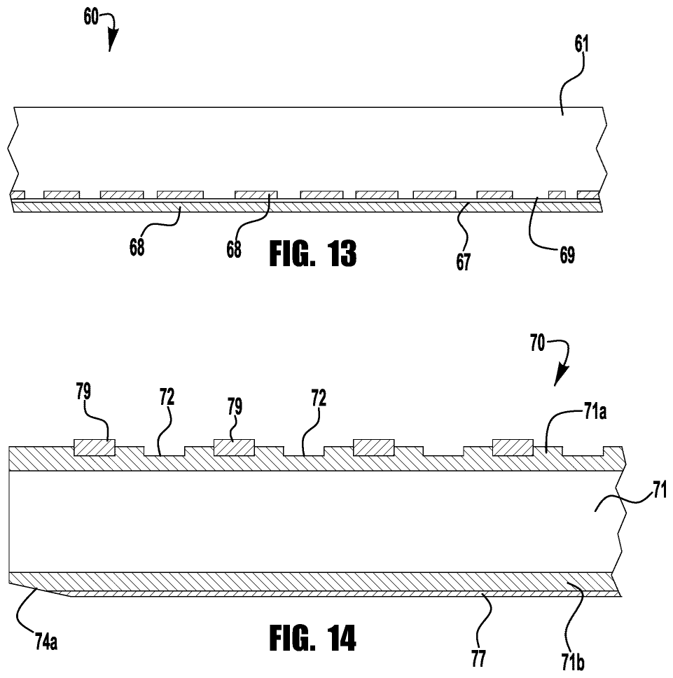

According to another exemplary aspect of the present disclosure, as shown in FIG. 13, an insulative panel 60 may be provided with a panel body 61 having a textured, roughened, or ridged front surface 69 to which a reinforcement mesh 67 is attached (e.g., in the field or pre-applied in the factory) by being adhered to raised portions of the textured surface. The textured front surface 69 may be prepared, for example, by injection molding, embossing, wire cutting, sanding, rasping. When the basecoat 68 is applied to the mesh-bearing front surface of the panel body 61, the liquid basecoat seeps under the mesh into the recessed portions of the textured surface, thereby at least partially encapsulating embedding the mesh 67 in the basecoat. This embedding of the mesh in the basecoat may produce improved performance adhesion values and improved impact resistance as compared, for example, to pinning the reinforcing mesh between the panel and the basecoat.

The insulative panels described herein may be formed from a variety of suitable materials, including, for example, expanded polystyrene (EPS) foam, extruded polystyrene (XPS) foam, polyurethane (PU) foam, and mineral wool. Insulative materials and panel thickness (e.g., between 1 and 12 inches) may be selected, for example, to provide a desired insulating R-value (e.g., an R-value of at least about R-4/inch nominal for a system between 1 and 12 inches thick), and/or based on other factors (e.g., cost, weight, inflammability, impact resistance). In some embodiments the panel material may include one or more additive materials, such as, for example, graphite, silicone, glass, or other such additive materials, for example, to provide enhanced properties, such as enhanced insulation (e.g., increased R-value), increased fire resistance, etc.

According to another exemplary aspect of the present disclosure, an insulative panel having one or more adapted front and/or rear features (e.g., one or more of the adapted features described herein) may be fabricated using a base panel element providing a desired material and thickness, and one or both of a rear facer element and a front facer element carrying the one or more adapted features. For example, as shown in FIG. 14, an insulative panel 70 may include a base panel element 71 providing a desired insulation material and thickness, and a rear facer element 71a attached to a rear surface of the base panel element and providing one or more of: drainage channel features (e.g., channels 72, as described above), pressure sensitive adhesive, mechanical fastening arrangements (e.g., mounting struts 79, as described above), and panel alignment elements, including but not limited to the examples described herein. As another example, as also shown in FIG. 14, an insulative panel 70 may include a base panel element 71 providing a desired insulation material and thickness, and a front facer element 71b attached to a front surface of the base panel element and providing one or more of: reinforcing material(s) (e.g., mesh 77, as described above), basecoat/architectural coating, textured coating receiving surfaces, tapered edge surfaces 74a, and panel alignment elements, including but not limited to the examples described herein. As still another example, shown in FIG. 14, an insulative panel 70 may include a base panel element 71 providing a desired insulation material and thickness, and front and rear facer elements 71b, 71a attached to the front and rear surfaces of the base panel element to provide one or more adapted features, such as, for example, the features described herein. In still other embodiments (not shown), an insulative panel may include a base panel element attached to either or both of front and rear facer element with one or more incorporated elements sandwiched or captured between the base panel element and the facer element(s), such as, for example, reinforcing material(s) (e.g., fiberglass mesh, rigid reinforcing struts), mechanical mounting features (e.g., mounting struts), and panel alignment elements (e.g., tongue/groove elements, peg/socket elements, or some other loose fit, press fit, snap fit, or other such interlocking geometric joint). The laminating or stacking of a base panel element with front and/or rear facer elements may additionally or alternatively allow for use of two or more different insulation materials. These laminated or stacked panel elements may be secured together using a variety of arrangements, including, for example, adhesive, glue, mechanical fasteners, co-molding, and/or coextrusion.

In an exemplary method of installing an insulative building wall cladding, a drainage channel defining rear surface of an insulative panel is secured to an exterior surface of a wall/structure (e.g., to an air/weather barrier applied to the wall/structure) using one or more non-drying/curing attachment arrangements (e.g., pressure sensitive adhesive and/or mechanical fasteners).

While various inventive aspects, concepts and features of the inventions may be described and illustrated herein as embodied in combination in the exemplary embodiments, these various aspects, concepts and features may be used in many alternative embodiments, either individually or in various combinations and sub-combinations thereof. Unless expressly excluded herein all such combinations and sub-combinations are intended to be within the scope of the present inventions. Still further, while various alternative embodiments as to the various aspects, concepts and features of the inventions—such as alternative materials, structures, configurations, methods, devices and components, alternatives as to form, fit and function, and so on—may be described herein, such descriptions are not intended to be a complete or exhaustive list of available alternative embodiments, whether presently known or later developed. Those skilled in the art may readily adopt one or more of the inventive aspects, concepts or features into additional embodiments and uses within the scope of the present inventions even if such embodiments are not expressly disclosed herein. Additionally, even though some features, concepts or aspects of the inventions may be described herein as being a preferred arrangement or method, such description is not intended to suggest that such feature is required or necessary unless expressly so stated. Still further, exemplary or representative values and ranges may be included to assist in understanding the present disclosure, however, such values and ranges are not to be construed in a limiting sense and are intended to be critical values or ranges only if so expressly stated. Parameters identified as “approximate” or “about” a specified value are intended to include both the specified value and values within 10% of the specified value, unless expressly stated otherwise. Further, it is to be understood that the drawings accompanying the present disclosure may, but need not, be to scale, and therefore may be understood as teaching various ratios and proportions evident in the drawings. Moreover, while various aspects, features and concepts may be expressly identified herein as being inventive or forming part of an invention, such identification is not intended to be exclusive, but rather there may be inventive aspects, concepts and features that are fully described herein without being expressly identified as such or as part of a specific invention, the inventions instead being set forth in the appended claims. Descriptions of exemplary methods or processes are not limited to inclusion of all steps as being required in all cases, nor is the order that the steps are presented to be construed as required or necessary unless expressly so stated.

1. An insulative panel comprising:
a panel body having opposed front and rear surfaces extending between first and second lateral edges and between first and second longitudinal edges, with a plurality of recessed drainage channels formed in the rear surface and extending from the first longitudinal edge to the second longitudinal edge.

2. The insulative panel of claim 1, wherein each of the plurality of recessed drainage channels extends parallel to the first and second lateral edges.

3. The insulative panel of claim 1, wherein each of the plurality of recessed drainage channels extends diagonally with respect to the first and second lateral edges.

4. The insulative panel of 3 claim 1, wherein the panel body includes a second plurality of recessed drainage channels formed in the rear surface and extending from the first lateral edge to the second lateral edge.

5.-15. (canceled)

16. The insulative panel of claim 1, wherein the panel body comprises a base panel element and a rear facer element secured to a rear surface of the base panel element, wherein the plurality of recessed drainage channels is formed in the rear facer element.

17. The insulative panel of claim 16, wherein one or more fastening elements are provided on the rear facer element.

18. An insulative panel comprising:
a panel body having opposed front and rear surfaces extending between first and second lateral edges and between first and second longitudinal edges;
a plurality of elongated rigid struts secured to the rear surface of the panel body, with end portions extending beyond the first and second longitudinal edges of the panel body for fastening to a building substrate.

19. The insulative panel of claim 18, wherein the plurality of elongated struts are at least partially embedded into the panel body.

20. The insulative panel of claim 18, wherein the plurality of elongated struts are at least partially received in mating channels in the rear surface of the panel body.

21. The insulative panel of claim 18, wherein each of the plurality of elongated struts includes an elongated rib portion received in a corresponding groove in the rear surface of the panel body.

22. The insulative panel of claim 18, wherein a rear surface of each of the plurality of struts is substantially flush with the rear surface of the panel body.

23. The insulative panel of claim 18, wherein a rear surface of each of the plurality of struts is offset from the rear surface of the panel body, such that when the plurality of struts is attached to a building substrate, a drainage space is defined between the building substrate and the panel body.

24.-34. (canceled)

35. An insulative panel comprising:
a panel body having opposed front and rear surfaces extending between first and second lateral edges and between first and second longitudinal edges;
a reinforcing material secured to the front surface of the panel body, wherein the front surface of the panel body comprises a textured surface defining raised portions and recessed portions, wherein the reinforcement material is adhered to the raised portions of the textured surface, and a basecoat is disposed over the reinforcement material and between the reinforcement material and the recessed portions of the textured surface to at least partially encapsulate the reinforcement material in the basecoat.

36. The insulative panel of claim 35, wherein the reinforcing material comprises at least one of a woven mesh, non-woven mat, or solid sheet material.

37. The insulative panel of claim 35, wherein the reinforcing material comprises at least one of fiberglass and polypropylene.

38. The insulative panel of claim 35, wherein the panel body comprises a base panel element and a front facer element secured to a front surface of the base panel element, wherein the reinforcement material is disposed on the front facer element.

39. The insulative panel of claim 35, wherein the panel body comprises a plurality of recessed drainage channels formed in the rear surface and extending from the first longitudinal edge to the second longitudinal edge.

40.-41. (canceled)

42. The insulative panel of claim 35, wherein the panel body comprises a base panel element and a rear facer element secured to a rear surface of the base panel element, wherein the one or more fastening elements are provided on the rear facer element.

43.-44. (canceled)

45. The insulative panel of claim 1, wherein at least one of the first and second lateral edges and the first and second longitudinal edges includes one or more interlocking features configured to interlock with corresponding interlocking features on a second insulative panel when the second insulative panel is installed adjacent to the insulative panel.

46. (canceled)

47. The insulative panel of claim 1, wherein the front surface of the panel body is outwardly tapered between a central portion and at least one of the first and second lateral edges and the first and second longitudinal edges.

48.-53. (canceled)
